(19) United States
(12) Patent Application Publication
(10) Pub. No.: US 2005/0139651 A1
(43) Pub. Date: Jun. 30, 2005

(54) Medical treatment management systems

(75) Inventors: Bernard C.B. Lim, Oakville (CA); Taras Worona, Etobicoke (CA); Davis A.R. Kanbergs, Milton (CA); Mark Paul Costa, Milton (CA); Hao Chen, Mississauga (CA); Roy T. Zhao, Brampton (CA); Gabriele Klein, Mississauga (CA); Kathleen Muller, Mississauga (CA); David G. Matsuura, Encinitas, CA (US); Philip J. Simpson, Escondido, CA (US); John Norris Mitchell, Hertfordshire (GB)

Correspondence Address: BURNS DOANE SWECKER & MATHIS L L P, POST OFFICE BOX 1404, ALEXANDRIA, VA, 22313-1404, US

(73) Assignee: VASOGEN IRELAND LIMITED, County Clare (IE)

(21) Appl. No.: 10/991,833

(22) Filed: Nov. 19, 2004

Related U.S. Application Data
(60) Provisional application No. 60/523,702, filed on Nov. 21, 2003.

(51) Int. Cl. G06K 5/00

(52) U.S. Cl. 235/380

(57) ABSTRACT

A medical treatment process and system, in which a patient fluid is subjected to extracorporeal handling and treatment prior to administration to the patient, is provided. The system includes two or more treatment units which successively handle the fluid, and a token associated with the patient. The token includes a patient identification and, as the treatment proceeds, more information is added to the token as the fluid moves around the system until the token contains a record of the treatment conducted on the sample, the times of various treatments, and a verification that treatment has been conducted in accordance with pre-determined criteria. The token, provided it contains information verifying the identity of the patient and treatment according to specification, allows administration of the treated fluid to the patient and provides an audit record of the treatment.

This application claims priority under 35 U.S.C. § 119(e) to U.S. provisional application No. 60/523,702 filed on Nov. 21, 2003.

### REFERENCE TO CO-PENDING APPLICATION

The entire subject matter of U.S. Provisional application Ser. No. 60/421,781 filed Oct. 29, 2002 and entitled DEVICE AND METHOD FOR CONTROLLED EXPRESSION OF GASES FROM MEDICAL FLUIDS DELIVERY SYSTEMS is incorporated by reference.

The entire subject matter of U.S. Provisional application Ser. No. 60/428,942 filed Nov. 26, 2002 and entitled BLOOD TREATMENT CONTROL SYSTEM is incorporated by reference.

The entire subject matter of U.S. Provisional application Ser. No. 60/464,659 filed Apr. 23, 2003 and entitled DISPENSING SYSTEMS is incorporated by reference.

The entire subject matter of U.S. Provisional application Ser. No. 60/482725 filed Jun. 27, 2003 and entitled MEDICAL TREATMENT CONTROL SYSTEM is incorporated by reference.

### BACKGROUND OF THE INVENTION

1. Field of the Invention

The present invention relates to the management of medical treatments.

2. Description of the Related Art

There has been, in recent years, tremendous changes in the way in which patients are treated. Most social Medicare systems have been changed to improve productivity. These changes have not occurred, however, without problems. A recent heart lung transplant surgery went horribly wrong because of a relatively minor oversight- a mismatch in the blood type of the donor and recipient patients. This event is overshadowed by accounts of patients being given the wrong medication. This suggests the need for improved monitoring of patients and their treatments to be sure they are given proper medications and/or medical procedures, given the specific, and perhaps unique, needs of each patient.

It is an object of the present invention to provide a novel medical treatment management system.

### SUMMARY OF THE INVENTION

The term “treatment device” used herein below is intended to mean a device used directly or indirectly in the course of a treatment. It may include devices which actually perform a medical treatment on the patient or a modification or handling treatment on a patient-derived sample, or alternatively be an article for performing functions associated with treatments, such as carrying or otherwise transferring the sample to or from a treatment and processing the sample. Several other examples of such treatment devices are described herein.

In one of its aspects, the present invention provides a method for controlling and recording the processing of a patient material sample for a patient, comprising the steps of:
equipping the patient with a machine-readable patient data token;
providing a treatment device;
providing the treatment device with a machine-readable treatment data token;
providing at least one correlation unit,
enabling the correlation unit to perform a correlation function between the patient data token and the treatment data tokens;
enabling the treatment device to carry out a treatment only when a correlation has been made between the patient data token and the treatment data token.

In another of its aspects, the present invention-additionally includes the steps of
providing a second treatment device;
providing the second treatment device with a machine-readable second treatment data token;
providing at least one correlation unit,
enabling the correlation unit to perform a correlation function between the patient data token and at least one of the treatment data tokens;
enabling at least one of the treatment devices to carry out a corresponding treatment only when a correlation has been made between the patient data token and the corresponding treatment data token.

In still another of its aspects, the present invention provides a method for controlling patient treatment records, comprising the steps of:
associating the patient with a machine-readable patient data token;
providing a first treatment device with a machine-readable first treatment data token,
transferring the patient data token to the first treatment device;
conducting a treatment on a patient material sample with the first treatment device
providing a second treatment device with a machine-readable second treatment data token;
transferring the patient data token and the first treatment data token from the first treatment device to the second treatment device;
conducting a treatment either on the patient or on the patient material sample with the second treatment device; and
transferring the patient data token, the first treatment data token and the second treatment data token to a recording station following the second treatment.

In yet another of its aspects, the present invention provides a method for controlling patient treatment records, comprising the steps of:
associating the patient with a machine-readable patient data token;
forming a treatment data packet to record one or more treatments on the patient or a patient material sample, the data packet including the patient data token;
providing a first treatment device with a machine-readable first treatment data token,
monitoring a first treatment with the first treatment device;
adding the first treatment data token to the treatment data packet;
providing a second treatment device with a machine-readable second treatment data token;
monitoring a second treatment with the second treatment device;
adding the second treatment data token to the treatment data packet; and
transferring the treatment data packet to a recording station following the second treatment.

From a further aspect, the present invention provides a system for controlling patient treatment records, comprising:
machine-readable patient data token means for associating a patient data token with a patient;
at least one treatment means for conducting a treatment on the patient or on a material sample from the patient;
machine-readable treatment data token means for associating at least one treatment data token with a corresponding treatment by the treatment means; and
data packet generating means for generating a treatment data packet to include the patient data token together with the treatment data token.

In one embodiment, the machine-readable patient data token means includes an article configured to be worn by, carried by or within, or attached to the patient. The treatment means includes a first treatment device and a second treatment device, while the machine-readable treatment data token means is operable for associating each treatment to be performed by each treatment device.

From a further aspect, the present invention provides a device for recording patient treatment data, comprising a portable article to be associated with a patient, the article including machine-readable patient data token means for associating a patient data token with the patient and token transfer means operable in one phase for delivering the patient data token to a treatment device or an intermediary device, and in another phase for receiving at least one treatment data token therefrom.

Also, according to another of its aspects, the present invention provides a computer program product encoded in a computer readable medium including a plurality of computer executable steps for a computer to control one or more treatments on a patient or a material sample therefrom, comprising:
a) executing a step to encode a patient data token to be associated with a patient;
b) executing a step to conduct a treatment either on the patient or on a material sample therefrom;
c) executing a step to encode a treatment data token to be associated with the treatment;
d) executing a step to encode a treatment data packet including or derived from the treatment data token and the patient data token.

Preferably, step d) includes the step of loading the treatment data packet on a portable article to be carried by, carried in, worn by or attached to, or associated with the patient.

In still another of its aspects, there is provided a computer program product encoded in a computer readable medium including a plurality of computer executable steps for a computer to control one or more treatments on a plurality of patients or a plurality of material samples therefrom, comprising:
a) executing a step to encode a plurality of patient data tokens, each to be associated with one of a plurality of patients;
b) executing a step to conduct a treatment on a plurality of patients or on a plurality of material samples from the patients;
c) executing a step to encode a plurality of treatment data tokens, each treatment data token to associated with each of said treatments;
d) executing a step to encode a treatment data packet for each of said patients, each data packet including or derived from the treatment data token and the patient data token; and
e) associating each treatment data packet with the corresponding patient.

Preferably, step e) includes the step of loading each treatment data packet on a portable article to be carried by, carried in, worn by or attached to, or associated with the corresponding patient.

Another aspect of the present invention is a computer-readable data structure for controlling patient treatment records, comprising a patient data token encoding a given patient and at least one treatment data token encoding at least treatment conducted on the patient or a material sample therefrom.

In still another of its aspects, there is provided a signal propagated on a carrier medium, the signal including a patient data token element encoding a given patient and at least one treatment data token element encoding at least treatment conducted on the patient or a material sample therefrom.

Thus, in one example, the system is capable of transferring a patient data token from an article being worn by or associated with a patient (such as a wrist band or its equivalent) to the one or more treatment devices as the treatment procedure progresses, before the treatment is begun or after the treatment is completed, as the case may be. The patient data token may also be equated to a key or a password to obtain permission for a particular treatment to occur. This permission may involve the collection of untreated blood, or the dispensing of treated blood or the like. In this case, the patient data token may be different from data relating to treatments recorded, measured or otherwise accumulated during the treatment. In this case, the treatment data token may be equated with audit data which, following the treatment procedure, may be used to review a patients particular treatment program, as the case may be.

In addition, this permission function may also preempt the delivery to the patient of a treated sample, or a token transfer unit or means, or one or more of the data tokens therein. In other words, the final delivery of the treated sample or one or more of the tokens may only proceed in this case, provided a positive correlation or verification is made between the originating patient and the treated sample or the data token. If a positive correlation cannot be made, the delivery is prevented. This may also apply to the ordering and delivery of drugs where a container or record may be dispatched to a pharmacy or other drug repository and then the required prescription filled and delivered to the patient only after a positive correlation is made.

### BRIEF DESCRIPTION OF THE DRAWINGS

Several preferred embodiments of the present invention will now be described, by way of example only, with reference to the appended drawings in which:

FIG. 1 is a schematic view of a medical treatment management system; and

FIG. 2 is a schematic view of an alternative medical treatment management system.

### DESCRIPTION OF THE PREFERRED EMBODIMENTS

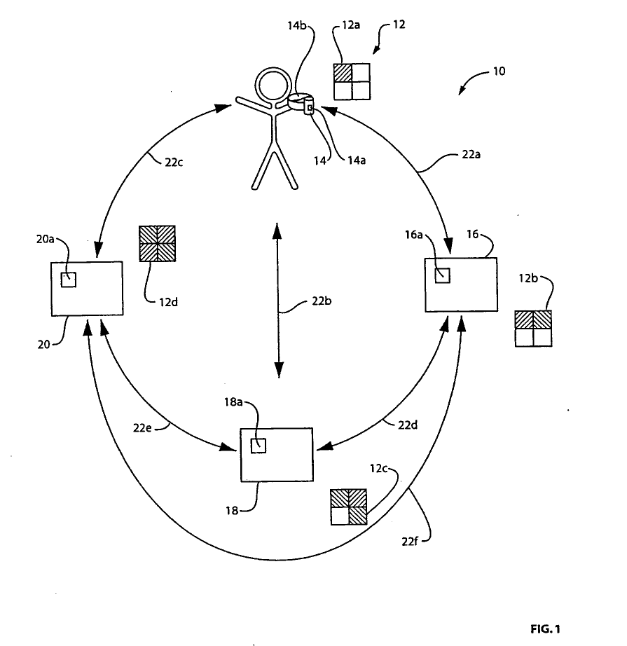

FIG. 1 illustrates a system 10 for managing the treatment and care of a patient. As will be more fully explained below, the system 10 is based on the principle that one or more machine-readable data “tokens”, labels or data are available to identity the patient and one or more treatment or procedural events for the patient. Each data token provides sufficient coordinate information to identify the patient or the treatment that was conducted on the patient or a patient derived sample. Accordingly, if the patient is subjected to one audited treatment, then the system tracks two data tokens, a patient data token and a first treatment data token. Together, these tokens provide a useful audit trail for the treatment performed. Indeed, in perhaps far more frequent cases, the patient is subjected to many treatments and procedures. Under the system 10, then, an audit trail can be established to record the relevant patient coordinate data as well as one, or more, or all, of the treatments and/or procedures.

Furthermore, the system 10 may be used to ensure that the correct treatment is conducted on the correct patient or patient derived sample. In so doing, the system 10 may be employed to perform a correlation function between the patient data token and the treatment data token. In this case, the system may be configured to enable a particular treatment to be carried out only when a correlation has been made between the patient data token and the treatment data token.

The data tokens may be collected in a number of forms, for example in a number of discrete forms such as mechanically prepared labels such as bar codes and the like. Alternatively, each data token may be packaged and transferred via a carrier signal, for example across a wired or wireless data link. These data tokens may be transmitted over an optical carrier wave transmitted on a fibre network, an RE carrier signal transmitted over an RE network or in other forms. The data tokens may be held, stored or otherwise retained in a data token “packet” which may, for instance, be a sub file or sector in a data base or on a memory device such as a memory chip, a magnetic memory strip, a hard drive, or the like.

In the system 10 shown in FIG. 1, there is a machine-readable data token packet shown by the representation 12, having four discrete areas. Each of the four areas or sections 12a, 12b, 12c and 12d constitutes a token beating sector which receives a discrete “token”, or package of information, in the form of electronic data received and stored directly on one of the sectors, or in a physical form such as a chip carrying data, a unique physical object such as a key, or the like. The patient data token and the data token packet 12 may, for example, be carried in an REID chip 14a which itself is located on a wrist band 14b. In this case, the REID chip also provides the function of a token transfer unit, since the RFJD chip is capable of transmitting the token to a suitably tuned REID receiver. The RFID chip may for example be of the active or passive type available from Microchip Technology Inc. under serial number MCR 45X, as described in microlDTNI MHz REID System Design Guide, the entire subject matter of which is incorporated herein by reference.

The token transfer unit 14 is enabled to collect, retrieve and/or store the patient data token relating to the patient, by receiving data token packet 12 carrying the patient data token as electronic data on sector 12a. In this case, the token transfer unit 14 may be operable to receive the patient data token from an REID writer unit at the time the patient enters the medical facility. The RFID chip may be powered internally or externally by such power sources as battery or an internal power generating module such as a solar power generator operating in the presence of solar radiation, or an inductive power generator operating in the presence of microwave or RE radiation. The power supply portion may include a conductive path to an external power source.

The system 10 includes a first treatment device shown generally at 16, a second treatment device shown generally at 18 and a third treatment device generally shown at 20. Three such treatment units are shown herein for illustrative purposes, it being understood that the system may be applicable to one treatment device, two treatment devices or any number of treatment devices as required.

The first, second and third treatment devices 16, 18 and 20 may each comprise one or more syringes, IV bottles, powder and/or atomized fluids and/or gas inhalant dispensers, implant delivery dispensers, ventilators, syringe pumps, intubation tubes, gastrointestinal feeding tubes, or a plurality and/or a combination thereof. One of the treatment devices may also comprise a blood treatment device such as that disclosed in PCT application serial number PCT/CA00/01078 filed September 2000 entitled APPARATUS AND PROCESS FOR CONDITIONING MAMMALIAN BLOOD (the entire contents of which are incorporated herein by reference). Alternatively, one treatment device may be equipped to perform a range of invasive and non-invasive treatments such as surgeries, treatments for diseases such as cancer, as well as exploratory or diagnostic investigations such as X-rays, CAT Scans, MRL's and the like.

The first, second and third treatment devices 16, 18 and 20 are each provided with machine-readable first, second and third treatment data tokens respectively, the first treatment data token being shown in sector 12b of the data token packet 12, the second treatment data token being shown in sector 12c, and the third treatment data token being shown in sector 12d.

The first and third treatment devices 16 and 20 are enabled to exchange one or more data tokens with the token transfer unit 14 along data paths 22a, 22c respectively. Optionally, the second treatment device 18 is enabled to exchange one or more data tokens with the token transfer unit 14 along data path 22b.

The first and second treatment devices 16 and 18 are enabled to exchange one or more data tokens with one another along data path 22d, while the second and third treatment devices 18 and 20 are enabled to exchange one or more data tokens with one another along data path 22e. Optionally, the first and third treatment devices 16 and 20 are enabled to exchange one or more data tokens with one another along data path 22f. Although the data paths are illustrated as being discrete and separate from one another, they may be provided by or included in one or more carrier signals between the various treatment devices and the token transfer unit.

If desired, any one of the treatment devices, the token transfer device or an intermediate device may be equipped with a correlation unit, for example as shown at 16a, 18a and 20a in FIG. 1, to perform a correlation function between the patient data token and at least one of the second treatment data token or the third treatment data token, in order to execute the treatment step or the step of injecting the patient with the treated blood, only on a proper match or correlation, as for example is described in U.S. Provisional application Ser. No. 60/428,942 filed Nov. 26, 2002 and entitled BLOOD TREATMENT CONTROL SYSTEM.

In this case, the step of transferring the body fluid from the third treatment device to the patient is permitted only when a correlation has been made between the patient data token and the corresponding treatment data token. This can be vitally important in procedures such as blood treatments and others, where the return of the treated sample to the patient of origin (autologous blood treatment for example) is essential. In addition to providing this essential feature of safety, embodiments of the invention can be arranged to keep a complete audit trail of the patient's treatments over an entire course of treatments, for recording medical progress, efficacy, appropriateness of treatment regimen, frequency of treatments, billing, adverse events, etc. There may be cases where the correlation function occurs indirectly between the patient data token and the treatment data tokens. For example, the correlation may be made between the patient data token and the first treatment data token, and thereafter between the first treatment data token and the second treatment data token once the previous data token has been properly verified.

The token transfer unit 14 is thus operable to receive the data packet 12 from the third treatment device 20. It will be understood that the function of the token transfer unit 14 (i.e. the transmission of the patient data token in the first instance, and the receipt of the accumulated data tokens in the data packet in the final instance), is also resident in each of the treatment devices, in order to allow the accumulated data token packet to be transferred from one treatment device to the next and finally to the token transfer unit 14. However, for the sake of brevity, only the token transfer unit 14 will be identified. On the other hand, there by may be instances where the function of the token transfer unit 14 is not resident in each of the treatment devices, but rather in one of the devices or in an intermediary unit, for example.

Thus, in one example, the data token packet 12 is transferred from the token transfer unit 14 to the first treatment device 16 with the first sector 12a containing the patient data token. The data token packet 12, in this case, is shown with four sectors to correspond to the patient data and the three treatments, it being understood that the data token packet may contain as many sectors as needed to accommodate the tokens from the treatment devices employed in any given application. If applicable, the correlation unit 1 6a performs a correlation function between the patient data token and the first treatment data token and, if the correction is made, the first treatment is carried out.

The data token packet 12 is then transferred from the first treatment device 16 to the second treatment device 18 with the sectors 12a, 12b carrying their corresponding patient data token and the first treatment data token, with the corresponding correlation function carried out, if applicable. The data token packet 12 is then transferred from the second treatment device 18 to the third treatment device 20 with the sectors 12a, 12b and 12c carrying their corresponding patient data token, as well as the first and second treatment data tokens, with the correlation function again carried out between the second treatment data token and the patient data token, if applicable. The data token packet 12 is finally transferred to the token transfer device 14 with the sectors 12a, 12b, 12c and 12d carrying their corresponding patient data token, as well as the first, second and third treatment data tokens, with the correlation function again carried out between the third treatment data token and the patient data token, if applicable. In this case, the data token packet 12 may be transferred to the token transfer device only if a positive correlation is made between the originating patient and the patient data token contained in the data token packet 12.

Thus, in the system 10, the data tokens are accumulated in a manner to form an audit trail or record which returns to the patient or an intermediary device, in the form of a data token packet containing all or selective data tokens relative to the treatments being conducted on the patient in a particular treatment period. For example a data token packet may be accumulated for each of a series of blood treatments over several treatment periods or for a single blood treatment.

Desirably, one or more of the treatment devices are operable to record when the treatment occurred by associating a time count with the corresponding treatment data token. Thus, one or more of the data tokens may also include a time stamp or some other time count indicating the time and/or date of the treatment.

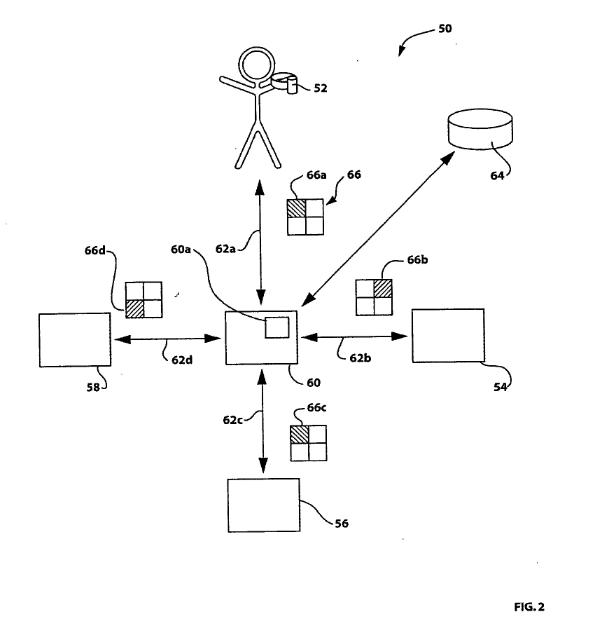

FIG. 2 illustrates an alternative system 50 having, as before, a patient wearable token transfer unit first, second and third treatment units 54, 56 and 58, all of which are enabled to communicate with an intermediate recording station 60. In this case, the intermediate recording station 60 may be provided with a memory portion such as a writable memory chip or a writable medium such as a hard drive, to store the data tokens received from the token transfer unit as well as from one or more of the treatment devices 54, 56 and 58 by way of a wired or wireless data link therebetween, as shown at 62a, 62b, 62c and 62d respectively.

The intermediate recording station 60 may include a data processing station 60a operable to exchange data with a central database 64. Thus, in the system 50, the data token packet shown at 66 is collected and stored in or by the intermediate recording station 60, but is not passed from one treatment device to the other as in the system 10. However, the system 50 does provide an effective audit trail or record for the treatments being carried out on the patient during a given treatment period.

The data token may thus be in machine readable electronic, graphical, mechanical or nuclear form and/or transferred via a carrier wave. The carrier wave may include radio frequency waves, microwaves or waves or signals of other frequencies or frequency ranges, with the signal carried by frequency modulation, amplitude modulation, wave superposition or a combination thereof. The patient data tokens may also include, for instance, data representative from or derived from a retinal scan image provided by a biometric sensor, a data code provided by an optical character reader, a bar code reader, a magnetic strip reader, or a combination thereof. In this case, the token transfer unit may include a signal emitter and/or receiver to emit and/or receive signals in the visible or invisible frequency spectrums.

In applications where one or more treatment devices is a syringe or a similar device, the data tokens may be embedded in or printed on a label or an outer surface of the syringe with or without additional identifying indicia printed thereon.

If desired, the patient data token and at least one of the first, second or third treatment data tokens may include mutually interfitting mechanical elements between the first token transfer unit and at least one of the second token transfer unit, the first treatment device, or the second treatment device or the third treatment device, as for example shown in U.S. Provisional application serial number filed Apr. 23, 2003 and entitled DISPENSING SYSTEMS.

The token transfer unit or the first, second and/or third treatment devices may include a programmed logic controller or some other form of controller. It may be included in a software program configured to run on a general purpose computer, such as personal computer, or on a more substantial computer mainframe, which is operable to work within a network, for patient data token data to be uploaded to a central database, or the treatment devices or token transfer unit remotely controlled or downloaded with fresh patient data token data. The network may thus involve several general purpose computers, for example those sold under the trade names APPLE™ or IBM™, or clones thereof, which are programmed with operating systems known by the trade names WINDOWS™, LINUX or other well known or lesser known equivalents of these. The system may involve pre-programmed software using a number of possible languages or a custom designed version of a programming software sold under the trade name ACCESS™ or similar programming software. The computer network may be a wired local area network, or a wide area network such as the Internet, or a combination of the two, with or without added security, authentication protocols, or under “peer-to-peer” or “client-server” or other networking architectures. The network may also be a wireless network or a combination of wired and wireless networks. The wireless network may operate under frequencies such as those dubbed ‘radio frequency’ or “RF” using protocols such as the 802.11, TCP/IP, BLUE TOOTH and the like, or other well known Internet, wireless, satellite or cell packet protocols. The system may, alternatively, include a single custom built computer which is dedicated to the function of the system alone.

The operation of the system 10 will be explained in the following example of blood treatment. In this case, the first treatment device 16 is a syringe which is employed to withdraw a sample or aliquot of body material, in the form of blood, from the patient. Either before, during or following the withdrawing step, the token transfer unit 14 transfers the data token packet 12 containing the patient data token and including the patient identification information, to the syringe 16. The patient identification information is also retained on unit 14 on the wristband. Also added to both the syringe correlation unit 16a and the wristband unit 14 is a first time stamp recording the time at which the blood aliquot was collected. Syringe correlation unit 16a may initially contain no information, except perhaps an identifier that it is intended for use in the system, until the wristband unit 14a reads the patient ID information to it.

The blood sample is then transferred from the syringe 16 to a blood treatment device 18, while the data token packet is transferred from the syringe 16 to the blood treatment device 18 containing the patient data token and a “sample withdrawal” data token. The blood treatment unit 18 carries correlation unit 18a which in this embodiment is an RFID read-writer. Unit 18a interrogates unit 16a on the syringe to verify that this is indeed a sample intended for treatment and that it is being received by the unit 18 within an appropriate pre-determined time frame. Once this has been verified, syringe 16 can be allowed to deliver its contents to the treatment unit 18. All the information from the syringe unit 16a, including the patient identification information and the first time stamp, is read and stored onto the RFID read-writer 18a. To this is added, on the read-writer 18a, treatment condition information to allow verification that pre-determined treatment conditions were followed, a second time stamp denoting the starting time of the treatment, and a third time stamp, denoting the time of conclusion of the treatment.

Alternatively, the step of withdrawing blood may be deemed as a step which does not need to be audited, in which case the transfer of the data token packet may occur between the token transfer unit 14 and the blood treatment device 18 directly, using data path 22b, with a “blood treatment” data token including a first time stamp indicating when the sample was transferred and a second time stamp indicating when the blood treatment step was carried out on the sample, provided a correlation is made between the “blood treatment” data token and the patient data token.

With the blood treatment completed, the treated blood sample is transferred from the blood treatment device 18 to a second, return syringe 20, constituting the third treatment unit The blood treatment device 18 transfers the data token packet 12 to the correlation unit 20a, an RFID chip, of the second syringe 20 together with the patient data token, the “sample withdrawal” data token (if included) and the “blood treatment” data token. At this point, a “blood delivery” sample token is added to the data token packet 12.

Thereafter, provided a positive correlation is made between the patient data token and the “blood delivery” data token, the data token packet 12 is transferred from the second syringe 20 to the token transfer unit 14 and the blood sample can exit from the return syringe 20 for delivery to the patient only if the wrist band 14 and unit 20a verify patient identity, appropriate treatment conditions and appropriate time elapses. All of the accumulated data is recorded on token transfer unit 14a, which thereby provides a complete audit trail of the treatment process.

Alternatively, the patient data token packet may be delivered directly or indirectly to a central data base for later management procedures or to a local memory device, such as a memory chip embedded in a patient chart or the like.

The blood treatment may be performed on a portion of or on the entire blood sample and may include treating the blood sample with oxidative stress, wherein the oxidative stress is ozone/oxygen gaseous mixture bubbled through, with or without UV radiation, heat or a combination thereof.

Alternatively, the blood treatment device may transfer the data token packet directly to the token transfer unit 14, together with the patient data token 12a, the “sample withdrawal” data token 12b (if included) and the “blood treatment” data token 12c, thereby bypassing a data token transfer to the second syringe 20. It is also contemplated that a number of iterative treatments may be conducted on a patient derived sample or the patient which may involve a number of sub-treatments each of which may include the sensing of one or more conditions, vital parameters of the patient or the sample (or environmental conditions, such as temperature, intensity of treatment, measured characteristics of the sample or patient) during the sub-treatment. In this case, the data accumulated in the data token packet 12 may include the results of the sub-treatments and the conditions that prevailed at each step.

As a further illustration, a treatment step may involve a feedback function, sensing the condition of an aliquot and treating the aliquot, while measuring parameters such as blood density, parameters of the treatment itself such as ozone or other stressor densities, gas mixtures and the like. The feedback function may then provide for improved treatments while the data token packet records one or more of those iterative steps.

In addition to autologous blood samples, it will be understood that the system, its components and alternatives thereof may be used for autologous samples other than blood samples, such as bone marrow or, lymphatic fluids, semen, ova- fluid mixtures, other bodily fluids or other medical fluids which may or may not be “autologous”, for example fluid mixtures perhaps containing a patient desired solid sample such as from organs, body cells and cell tissue, skin cells and skin samples, spinal cords. All such fluids, along with blood, are embraced by the the term “patient material” used herein. The system may also be used for medical testing where it is important to ensure that test results of a particular test can be delivered to the originating patient.

1. A method for treating a patient, comprising the steps of:
equipping the patient with a machine-readable patient data token;
providing a first treatment device;
providing the first treatment device with a machine-readable treatment data token;
providing at least one correlation unit,
enabling the correlation unit to perform a correlation function between the patient data token and the first treatment data token;
enabling the treatment device to carry out a treatment only when a correlation has been made between the patient data token and the treatment data token.

2. The method of claim 1 additionally comprising the steps of:
providing a second treatment device;
providing the second treatment device with a machine-readable second treatment data token;
enabling the correlation unit to perform a correlation function between the patient data token and at least one of the treatment data tokens;
enabling at least one of the treatment devices to carry out a corresponding treatment only when a correlation has been made between the patient data token and the corresponding treatment data token.

3. A method as defined in claim 2 wherein the first treatment device is a dispenser for medical material.

4. A method as defined in claim 3, further comprising the step of withdrawing body material from the patient with the first treatment device.

5. A method as defined in claim 4 wherein the body material includes a body fluid.

6. A method as defined in claim 5 further comprising the step of transferring the body fluid from the first treatment device to the second treatment device.

7. A method as defined in claim 4, wherein the second treatment device conducts treatment on the body fluids.

8. A method as defined in claim 7, further comprising the steps of:
providing a third treatment device; and
providing the third treatment device with a machine-readable third treatment data token.

9. A method as defined in claim 8 wherein the first, second or third treatment devices include a syringe, an IV bottle, a powder and/or atomized fluid and/or gas inhalant dispenser, an implant delivery dispenser, a ventilator, a syringe pump, an intubation tube, or a gastrointestinal feeding tube or a plurality and/or a combination thereof.

10. A method as defined in claim 8, wherein following the treatment of the body material by the second treatment device, the method further comprises the step of transferring the body material from the second treatment device to the third treatment device.

11. A method as defined in claim 10 further comprising the steps of:
enabling the correlation unit to perform a correlation function between the patient data token and the third treatment data token; and
transferring the body material from the third treatment device to the patient only when a correlation has been made between the patient data token and the corresponding treatment data token to correlate the patient with the body material.

12. A method as defined in claim 8, further comprising the step of providing the patient with a token transfer unit which is operable to exchange data tokens with the first, second or third treatment devices or with an intermediate device.

13. A method as defined in the claim 12 wherein the data tokens are exchanged over a wired or wireless data link, or a combination thereof.

14. A method as defined in claim 13 wherein the data link is established over a radio frequency signal.

15. A method as defined in claim 14 wherein the patient data token includes indicia representative of the patient.

16. A method as defined in claim 15 wherein the patient data token indicia includes at least one bar code.

17. A method as defined in claim 12 wherein the intermediate device includes a data processing station operable to exchange data with a central database.

18. A method as defined in claim 12 wherein the patient data token and at least one of the first, second or third treatment data tokens include mutually interfitting mechanical elements between the token transfer unit and at least one of the first treatment device, the second treatment device or the third treatment device.

19. A method as defined in claim 11 wherein the body material includes an aliquot of whole blood.

20. A method as defined in claim 19 wherein at least a portion of the aliquot is treated by the first, second or third treatment devices.

21. A method as defined in claim 20 wherein the first treatment device is a syringe to receive the aliquot and the first treatment data token includes identifying indicia printed on the syringe.

22. A method as defined in claim 21 wherein the patient data token and the first treatment data token include at least one bar code.

23. A method as defined in claim 22 wherein, following treatment, the aliquot is transferred from said first syringe to a treatment container for conducting the treatment in the second treatment device.

24. A method as defined in claim 23 wherein, following treatment, the aliquot is transferred from the treatment container to the third treatment device.

25. A method as defined in claim 24 wherein the third treatment device is a second syringe and the third treatment data token includes identifying indicia printed on the second syringe.

26. A method as defined in claim 25 wherein the third treatment data token includes at least one bar code.

27. A method as defined in claim 26 wherein the correlation function includes the step of correlating the bar code on the second syringe with a bar code on the patient data token.

28. A method as defined in claim 24 wherein the blood aliquot is treated with oxidative stress.

29. A method as defined in claim 28 wherein the oxidative stress is ozone/oxygen gaseous mixture bubbled through.

30. A method as defined in claim 29 wherein the blood aliquot is treated with UV radiation.

31. A method as defined in claim 29 wherein the blood aliquot is treated with heat.

32. A method as defined in claim 29 wherein the blood is treated simultaneously with at least two of UV, oxygen/ozone and heat.

33. A method for controlling patient treatment records, comprising the steps of:
associating the patient with a machine-readable patient data token;
providing a first treatment device with a machine-readable first treatment data token, -transferring the patient data token to the first treatment device;
conducting a treatment either on the patient or on a patient material sample with the first treatment device;
providing a second treatment device with a machine-readable second treatment data token;
transferring the patient data token and the first treatment data token from the first treatment device to the second treatment device;
conducting a treatment either on the patient or on the patient material sample with the second treatment device; and
transferring the patient data token, the first treatment data token and the second treatment data token to a recording station following the second treatment.

34. A method as defined in claim 33 wherein the recording station is included in the first treatment device, the second treatment device, or a recording device separate from the first and second treatment devices

35. A method as defined in claim 34 wherein the recording station is included in an article to be associated with the patient.

36. A method as defined in claim 35 wherein the article is wearable by the patient.

37. A method as defined in claim 36, further including the steps of associating a time count with one or more of said treatments and adding data representative of the time count to the corresponding one or more treatment data tokens.

38. A method for controlling patient treatment records, comprising the steps of:
associating the patient with a machine-readable patient data token;
forming a treatment data packet to record one or more treatments on the patient or a patient material sample, the data packet including the patient data token;
providing a first treatment device with a machine-readable first treatment data token,
monitoring a first treatment with the first treatment device;
adding the first treatment data token to the treatment data packet;
providing a second treatment device with a machine-readable second treatment data token;
monitoring a second treatment with the second treatment device;
adding the second treatment data token to the treatment data packet; and
transferring the treatment data packet to a recording station following the second treatment.

39. A method as defined in claim 33 wherein the recording station is included in the first treatment device, the second treatment device, or a recording device separate from the first and second treatment devices.

40. A method as defined in claim 39 wherein the recording station is included in an article to be associated with the patient.

41. A method as defined in claim 40 wherein the article is wearable by the patient.

42. A method as defined in claim 38, further including the steps of associating a time count with the first and/or second treatments and adding data representative of the time count to the corresponding first and/or treatment data tokens.

43. A system for controlling patient treatment records, comprising:
machine-readable patient data token means for associating a patient data token with a patient;
at least one treatment means for conducting a treatment on the patient or on a material sample from the patient;
machine-readable treatment data token means for associating at least one treatment data token with a corresponding treatment by the treatment means; and
data packet generating means for generating a treatment data packet to include the patient data token together with the treatment data token.

44. A system as defined in claim 43 wherein the machine-readable patient data token means includes an article configured to be worn by, carried by or within, or attached to the patient.

45. A system as defined in claim 43, wherein the treatment means includes a first treatment device and a second treatment device, the machine-readable treatment data token means being operable for associating a treatment data tokens with each of the treatments to be performed by the first and second treatment devices.

46. A device for recording patient treatment data, comprising a portable article to be associated with a patient, the article including machine-readable patient data token means for associating a patient data token with the patient and token transfer means operable in one phase for delivering the patient data token to a treatment device or an intermediary device, and in another phase for receiving at least one treatment data token therefrom.

47. A computer program product encoded in a computer readable medium including a plurality of computer executable steps for a computer to control one or more treatments on a patient or a material sample therefrom, comprising:
a) executing a step to encode a patient data token to be associated with a patient;
b) executing a step to conduct a treatment either on the patient or on a material sample therefrom;
c) executing a step to encode a treatment data token to be associated with the treatment;
d) executing a step to encode a treatment data packet including or derived from the treatment data token and the patient data token.

48. A product as defined in claim 47, wherein step d) includes the step of loading the treatment data packet on a portable article to be carried by, carried in, worn by, attached to, or associated with the patient.

49. A computer program product encoded in a computer readable medium including a plurality of computer executable steps for a computer to control one or more treatments on a plurality of patients or a plurality of material samples therefrom, comprising:
a) executing a step to encode a plurality of patient data tokens, each to be associated with one of a plurality of patients;
b) executing a step to conduct a treatment on a plurality of patients or on a plurality of material samples from the patients;
c) executing a step to encode a plurality of treatment data tokens, each treatment data token to associated with each of said treatments;
d) executing a step to encode a treatment data packet for each of said patients, each data packet including or derived from the treatment data token and the patient data token; and
e) associating each treatment data packet with the corresponding patient.

50. A product as defined in claim 49, wherein step e) includes the step of loading each treatment data packet on a portable article to be carried by, carried in, worn by or attached to, or associated with the corresponding patient.

51. A computer-readable data structure for controlling patient treatment records, comprising a patient data token encoding a given patient and at least one treatment data token encoding at least treatment conducted on the patient or a material sample therefrom.

52. A signal propagated on a carrier medium, the signal including a patient data token element encoding a given patient and at least one treatment data token element encoding at least treatment conducted on the patient or a material sample therefrom.
